(19) United States
(12) Patent Application Publication
(10) Pub. No.: US 2024/0351312 A1
(43) Pub. Date: Oct. 24, 2024

(54) GLASS LAMINATES HAVING DETERMINED STRESS PROFILES AND METHODS OF MAKING THE SAME

(71) Applicant: CORNING INCORPORATED, CORNING, NY (US)

(72) Inventors: Jason Thomas Harris, Horseheads, NY (US); Jin Su Kim, Seoul (KR); Peter Joseph Lezzi, CORNING, NY (US); Natesan Venkataraman, Painted Post, NY (US)

(21) Appl. No.: 18/761,977

(22) Filed: Jul. 2, 2024

Related U.S. Application Data
(62) Division of application No. 17/605,103, filed on Oct. 20, 2021, now Pat. No. 12,064,938.
(60) Provisional application No. 62/837,411, filed on Apr. 23, 2019.

(51) Int. Cl. B32B 17/06; B32B 7/027; C03B 17/06; C03B 27/04; C03B 27/052; C03C 21/00; C03C 23/00

(52) U.S. Cl. CPC B32B 17/06; C03B 17/064; C03B 27/0413; C03B 27/0526; C03C 21/002; C03C 23/007; B32B 7/027; B32B 2307/50; C03C 2203/50

(57) ABSTRACT

A laminated glass article comprises a core layer comprising a core glass composition having an average core coefficient of thermal expansion (CTE_{core}) and a clad layer directly adjacent to the core layer and comprising a clad glass composition having an average clad coefficient of thermal expansion (CTE_{clad}) that is less than the CTE_{core} such that the clad layer is in compression and the core layer is in tension. A compressive stress of the clad layer increases with increasing distance from the outer surface of the clad layer, transitions to a minimum tensile stress as a step-change at an interface region between the core layer and the clad layer, and a magnitude of the tensile stress increases continuously to a maximum tensile stress in the core layer. Other stress profiles, and methods of preparing laminated glass articles are also disclosed.

### CROSS-REFERENCE TO RELATED APPLICATIONS

This application is a divisional application of U.S. patent application Ser. No. 17/605,103, filed on Oct. 20, 2021, which is a National Stage application under 35 U.S.C § of International Application No. PCT/US2020/027913, filed on Apr. 13, 2020, which claims the benefit of priority under 35 U.S.C. § 119 of U.S. Provisional Application Ser. No. 62/837,411 filed on Apr. 23, 2019, the content of each of which is relied upon and incorporated herein by reference in its entirety.

### FIELD

The present specification generally relates to glass articles and, more particularly, to laminated glass articles including a plurality of glass layers and methods for forming the same.

### TECHNICAL BACKGROUND

Glass articles can be used in a wide variety of products, including, for example, auto-glazing, architectural panels, appliances, and cover glasses (e.g., for touch-screen devices such as smartphones, tablets, laptop computers, and monitors). Relatively large flaws can be introduced into the surfaces of the glass articles during use. For example, when a smartphone is dropped onto a rough surface, such as asphalt, the local indention caused by contact with sharp features of the rough surface can cause flaws as deep as about 300 μm in the surface of the cover glass.

Accordingly, a need exists for glass articles with improved resistance to breakage caused by deep flaws, improved mechanical reliability, and improved drop performance.

### SUMMARY

According to various aspects disclosed herein, a laminated glass article comprises a core layer comprising a core glass composition having an average core coefficient of thermal expansion (CTE_{core}) and a clad layer directly adjacent to the core layer and comprising a clad glass composition having an average clad coefficient of thermal expansion (CTE_{clad}) that is less than the CTE_{core} such that the clad layer is in compression and the core layer is in tension. A compressive stress of the clad layer increases with increasing distance from the outer surface of the clad layer, transitions to a minimum tensile stress as a step-change at an interface region between the core layer and the clad layer, and a magnitude of tensile stress increases continuously from the step-change to a maximum tensile stress in the core layer.

Another aspect includes the laminated glass article of the previous aspect, wherein a surface compressive stress of the clad layer is at least 200 MPa.

Another aspect includes the laminated glass article of any of the previous aspects, wherein a surface compressive stress of the clad layer is at least 250 MPa.

Another aspect includes the laminated glass article of any of the previous aspects, wherein the laminated glass article comprises a depth of compression of up to 50 μm.

According to other aspects disclosed herein, a method of preparing a glass article comprises laminating at least one core layer and at least one clad layer to form a laminated glass article, the at least one core layer comprising a core glass composition having an average core coefficient of thermal expansion (CTE_{core}) and the at least one clad layer comprising a clad glass composition having an average clad coefficient of thermal expansion (CTE_{clad}) that is less than the CTE_{core} such that the at least one clad layer is in compression and the at least one core layer is in tension, heating the laminated glass article to a first temperature that is from 50° C. to 200° C. greater than a glass transition temperature T_{g} of the laminated glass article, equilibrating the laminated glass article at the first temperature for a predetermined period of time, and quenching the laminated glass article to a second temperature below a strain point of the laminated glass article.

Another aspect includes the method of the previous aspect, wherein the first temperature is greater than or equal to 750° C. and less than or equal to 900° C.

Another aspect includes the method of any of the previous aspects, wherein the second temperature is 25° C.±10° C.

Another aspect includes the method of any of the previous aspects, further comprising subjecting the laminated glass article to an ion exchange treatment.

Another aspect includes the method of any of the previous aspects, wherein after quenching, a compressive stress of the clad layer increases with increasing distance from the outer surface of the clad layer, transitions to a minimum tensile stress as a step-change at an interface region between the core layer and the clad layer, and a magnitude of tensile stress increases continuously from the step-change to a maximum tensile stress in the core layer.

Another aspect includes the method of any of the previous aspects, wherein after quenching, a surface compressive stress of the clad layer is at least 200 MPa.

According to aspects disclosed herein, a laminated glass article comprises a core layer comprising a core glass composition having an average core coefficient of thermal expansion (CTE_{core}) and a clad layer directly adjacent to the core layer and comprising a clad glass composition and having an average clad coefficient of thermal expansion (CTE_{clad}) that is less than the CTE_{core} such that the clad layer is in compression and the core layer is in tension. A compressive stress of the clad layer decreases with increasing distance from the outer surface of the clad layer, transitions to a minimum tensile stress as a step-change at an interface region between the core layer and the clad layer, and a tensile stress increases continuously from the step-change to a maximum tensile stress in the core layer.

Another aspect includes the glass article of the previous aspect, wherein a surface compressive stress of the clad layer is at least 500 MPa.

Another aspect includes the glass article of any of the previous two aspects, wherein the minimum tensile stress is at least 50 MPa.

Another aspect includes the glass article of any of the previous three aspects, wherein the compressive stress decreases with increasing distance from the outer surface of the clad layer in according to a non-linear relationship.

Another aspect includes the glass article of any of the previous four aspects, wherein the tensile stress increases to a maximum tensile stress according to a non-linear relationship.

According to other aspects disclosed herein, a method of preparing a glass article comprises laminating at least one core layer and at least one clad layer to form a laminated glass article, the at least one core layer comprising an ion-exchangeable core glass composition having an average core coefficient of thermal expansion (CTE_{core}) and the at least one clad layer comprising an ion-exchangeable clad glass composition having an average clad coefficient of thermal expansion (CTE_{clad}) that is less than the CTE_{core} such that the at least one clad layer is in compression and the at least one core layer is in tension; and contacting the laminated glass article with an ion exchange bath comprising a first ion source and a second ion source. After the contacting, the laminated glass article has a depth of compression (DOC) of greater than or equal to 50 μm.

Another aspect includes the method of the previous aspect, wherein after the contacting, the laminated glass article has a DOC of greater than or equal to 70 μm.

Another aspect includes the method of any of the previous two aspects, wherein after the contacting, the laminated glass article has a DOC of greater than or equal to 100 μm.

Another aspect includes the method of any of the previous three aspects, wherein after the contacting, the laminated glass article has a DOC of greater than or equal to 200 μm.

Another aspect includes the method of any of the previous four aspects, wherein the ion exchange bath is a first ion exchange bath, the method further comprising contacting the laminated glass article with a second ion exchange bath comprising at least one additional ion source. Alternatively, the aspect may include the method of any of the previous four aspects, wherein contacting the laminated glass article with an ion exchange bath comprises contacting the laminated glass article with a first ion exchange bath comprising the first ion source and subsequently contacting the laminated glass article with a second ion exchange bath comprising the second ion source.

Another aspect includes the method of any of the previous five aspects, wherein the first ion source comprises a source of sodium ions, and the second ion source comprises a source of potassium ions.

Another aspect includes the method of any of the previous seven aspects, further comprising, prior to contacting the laminated glass article with the ion exchange bath: heating the laminated glass article to a first temperature that is from 50° C. to 200° C. greater than a glass transition temperature T_{g} of the laminated glass article; equilibrating the laminated glass article at the first temperature for a predetermined period of time; and quenching the laminated glass article to a second temperature.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a cross-sectional view of a glass article in accordance with one or more embodiments shown and described herein;

FIG. 2 is a cross-sectional view of an overflow distributor that can be used to form a glass article in accordance with one or more embodiments shown and described herein;

FIG. 3 is a plot of the stress profiles of an example embodiment and a comparative example in which stress is plotted on the y-axis and depth within the glass article is plotted on the x-axis;

FIG. 4 is a plot of the retained strength profile of an example embodiment and three comparative examples in which retained strength is plotted on the y-axis and flaw size is plotted on the x-axis;

FIG. 5 is a plot of the residual stress of an example embodiment and three comparative examples in which the residual stress is plotted on the y-axis and the depth is plotted on the x-axis;

FIG. 6 is a schematic cross-sectional view of a ring-on-ring apparatus;

FIG. 7 is a plot of the results of the abraded ring-on-ring test for Example 1 and Comparative Examples A, B, D, and I in which the load to failure is plotted on the y-axis and the abrasion pressure is plotted on the x-axis;

FIG. 8 is a plot of the residual stress of a laminated glass article having a CTE mismatch between layers of the glass article and the residual stress of a single layer of glass that was chemically strengthened in which the residual stress is plotted on the y-axis and the depth is plotted on the x-axis;

FIG. 9 is a plot of various examples of stress profiles formed from chemical strengthening and combined stress profiles formed a combination of mechanical strengthening and chemical strengthening in which the residual stress is plotted on the y-axis and the depth is plotted on the x-axis;

FIG. 10 is a plot of various examples of retained strength profiles formed from chemical strengthening and combined retained strength profiles formed a combination of mechanical strengthening and chemical strengthening in which the retained strength is plotted on the y-axis and the depth is plotted on the x-axis;

FIG. 11 is a plot of the residual stress of various example embodiments and comparative examples in which the residual stress is plotted on the y-axis and the depth is plotted on the x-axis; and

FIG. 12 is a plot of the retained strength of various example embodiments and comparative examples in which the retained strength is plotted on the y-axis and the depth is plotted on the x-axis.

### DETAILED DESCRIPTION

Reference will now be made in detail to various embodiments, examples of which are illustrated in the accompanying drawings. Whenever possible, the same reference numerals will be used throughout the drawings to refer to the same or like parts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise. Also, the word “or” when used without a preceding “either” (or other similar language indicating that “or” is unequivocally meant to be exclusive-e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated.

In various embodiments, one or more properties of the glass article are improved by use of a post-forming fictivation process. As used herein, “fictivation” refers to imposing a specified fictive temperature or thermal history on a glass through appropriate heat treatment. As used herein, the term “fictive temperature” refers to the temperature which reflects the structural contribution to the enthalpy of the glass. The fictive temperature of a glass may be determined by calorimetric methods, as described by Xiaoju Guo et al. in “Unified approach for determining the enthalpic fictive temperature of glasses with arbitrary thermal history,” (Journal of Non-Crystalline Solids 357 (2011) pp. 3230-3236), the contents of which are incorporated herein by reference in their entirety. In the glasses described herein, the fictive temperature is from 50° C. to 200° C. greater than the glass transition temperature (T_{g}) of the glass article.

### Glass Laminates

In various embodiments, a glass article comprises at least a first layer and a second layer. For example, the first layer comprises a core layer, and the second layer comprises one or more clad layers adjacent to the core layer. The first layer and/or the second layer are glass layers comprising a glass material, a ceramic material, a glass-ceramic material, or a combination thereof. In some embodiments, the first layer and/or the second layer are transparent glass layers.

The core layer has an average core CTE (core CTE or CTE_{core}), and the clad layer has an average clad CTE (clad CTE or CTE_{clad}). For example, the core layer is formed from a first glass composition with the core CTE and the clad layer is formed from a second glass composition with the clad CTE. The core CTE is greater than the clad CTE such that the core layer is in tension and the clad layer is in compression, prior to any heat treatment or ion exchange. In some embodiments, a stress profile of the glass laminate comprises a compressive stress peak disposed within the clad layer (e.g., between an outer surface of the clad layer and an inner surface of the clad layer). Additionally, or alternatively, the stress profile of the glass laminate may comprise a continuously increasing region disposed within the clad layer (e.g., the compressive stress increases between the outer surface of the clad layer and the depth of compression, excluding any compressive stress spike). In some embodiments, a compressive stress of the clad layer increases with increasing depth within the glass article to the interface between the clad layer and the core layer. In still other embodiments, a stress profile of the glass laminate comprises a compressive stress peak at the surface of the glass laminate and a compressive stress that continuously decreases with increasing depth within the glass article to the interface between the clad layer and the core layer.

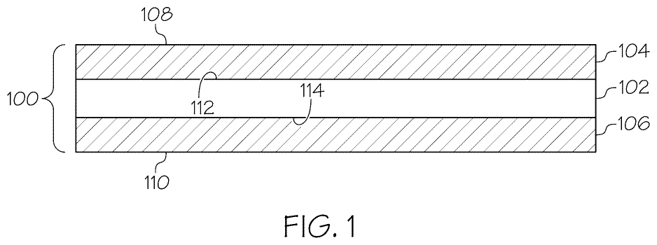

FIG. 1 is a cross-sectional view of one embodiment of a glass article 100. The glass article 100 is a laminated sheet including a plurality of glass layers. In embodiments, the laminated sheet may be substantially planar, as shown in FIG. 1, or the laminated sheet may be non-planar. The glass article 100 comprises a core layer 102 disposed between a first clad layer 104 and a second clad layer 106. In some embodiments, the first clad layer 104 and the second clad layer 106 are exterior layers relative to the core layer 102, as shown in FIG. 1. For example, an outer surface 108 of the first clad layer 104 is an outer surface of the glass article 100 and/or an outer surface 100 of the second clad layer 106 is an outer surface of the glass article 100. In other embodiments, the first clad layer 104 and/or the second clad layer 106 are intermediate layers disposed between the core layer 102 and an exterior layer (not shown).

The core layer 102 comprises a first major surface and a second major surface opposite the first major surface. In some embodiments, the first clad layer 104 is fused to the first major surface of the core layer 102. Additionally or alternatively, the second clad layer 106 is fused to the second major surface of the core layer 102. In such embodiments, an interface 112 between the first clad layer 104 and the core layer 102 and/or an interface 114 between the second clad layer 106 and the core layer 102 are free of any bonding material such as, for example, an adhesive, a coating layer, or any non-glass material added or configured to adhere the respective clad layers to the core layer. Thus, the first clad layer 104 and/or the second clad layer 106 are fused directly to the core layer 102 and/or are directly adjacent to the core layer 102. In some embodiments, the glass article 100 includes one or more intermediate layers disposed between the core layer and the first clad layer and/or between the core layer and the second clad layer. For example, the intermediate layers may comprise intermediate glass layers and/or diffusion layers formed at the interface of the core layer and the clad layer. The diffusion layer can comprise a blended region comprising components of each layer adjacent to the diffusion layer (e.g., a blended region between two directly adjacent glass layers). In some embodiments, the glass article 100 comprises a glass-glass laminate in which the interfaces between directly adjacent glass layers are glass-glass interfaces.

In some embodiments, the core layer 102 comprises a first glass composition and first and/or second clad layers 104, 106 comprise a second glass composition that is different than the first glass composition. The first glass composition and the second glass composition are different from each other prior to chemically strengthening the glass article 100 as described herein. For example, in the embodiment shown in FIG. 1, the core layer 102 comprises the first glass composition and each of the first clad layer 104 and the second clad layer 106 comprises the second glass composition. In other embodiments, the first clad layer comprises the second glass composition and the second clad layer comprises a third glass composition that is different than the first glass composition and/or the second glass composition.

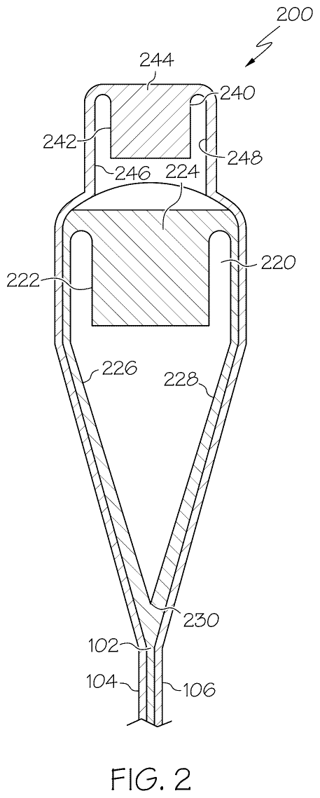

The glass article can be formed using a suitable process such as, for example, a fusion draw, down draw, slot draw, up draw, or float process. In some embodiments, the glass article 100 is formed using a fusion draw process. FIG. 2 is a cross-sectional view of an example embodiment of overflow distributor 200 that can be used to form a glass article such as, for example, the glass article 100.

The overflow distributor 200 can be configured as described in U.S. Pat. No. 4,214,886, which is incorporated by reference in its entirety. For example, the fusion draw apparatus 200 includes a lower overflow distributor 220 and an upper overflow distributor 240 positioned above the lower overflow distributor 220. The lower overflow distributor 220 includes a trough 222. A first glass composition 224 is melted and fed into the trough 222 in a viscous state. The first glass composition 224 forms the core layer 102 of the glass article 100 as further described below. The upper overflow distributor 240 includes a trough 242. A second glass composition 244 is melted and fed into the trough 242 in a viscous state. The second glass composition 244 forms first and second clad layers 104, 106 of the glass article 100 as further described below.

The first glass composition 224 overflows trough 222 and flows down opposing outer forming surfaces 226 and 228 of the lower overflow distributor 220. The outer forming surfaces 226 and 228 converge at a draw line 230. The separate streams of the first glass composition 224 flowing down respective outer forming surfaces 226 and 228 of the lower overflow distributor 220 converge at the draw line 230 where they are fused together to form the core layer 102 of the glass article 100.

The second glass composition 224 overflows the trough 242 and flows down opposing outer forming surfaces 246 and 248 of the upper overflow distributor 240. The second glass composition 244 is deflected outward by the upper overflow distributor 240 such that the second glass composition 244 flows around the lower overflow distributor 220 and contacts the first glass composition 224 flowing over the outer forming surfaces 226 and 228 of the lower overflow distributor 220. The separate streams of the second glass composition 244 are fused to the respective separate streams of the first glass composition 224 flowing down the respective outer forming surfaces 226 and 288 of the lower overflow distributor 220. Upon convergence of the streams of the first glass composition 224 at the draw line 230, the second glass composition 244 forms first and second clad layers 104, 106 of the glass article 100.

In some embodiments, the first glass composition 224 of the core layer 102 in the viscous state is contacted with the second glass composition 244 of the first and second clad layers 104, 106 in the viscous state to form the laminated sheet. In some of such embodiments, the laminated sheet is part of a glass ribbon traveling away from the draw line 230 of the lower overflow distributor 220, as shown in FIG. 2. The glass ribbon can be drawn away from the lower overflow distributor 220 by a suitable means including, for example, gravity and/or pulling rollers. The glass ribbon cools as it travels away from the lower overflow distributor 220. The glass ribbon is severed to separate the laminated sheet therefrom. Thus, the laminated sheet is cut from the glass ribbon. The glass ribbon can be severed using a suitable technique such as, for example, scoring, bending, thermally shocking, and/or laser cutting. In some embodiments, the glass article 100 comprises the laminated sheet as shown in FIG. 1. In other embodiments, the laminated sheet can be processed further (e.g., by cutting or molding) to form the glass article.

Although the glass article 100 is shown in FIG. 1 as including three layers, other embodiments are contemplated. For example, the glass article may have two, four, or more layers. Glass articles including two layers can be formed using two overflow distributors positioned such that the two layers are joined while traveling away from the respective draw lines of the overflow distributors or by using a single overflow distributor with a divided trough such that two glass compositions flow over opposing outer forming surfaces of the overflow distributor and converge at the draw line of the overflow distributor. Glass articles including four layers can be formed using additional overflow distributors and/or using overflow distributors with divided troughs. Thus, a glass article having a predetermined number of layers can be formed by modifying the overflow distributor accordingly.

Although the glass article 100 is shown in FIG. 1 as comprising a laminated sheet, other forms are contemplated. For example, the glass article may be in the form of a laminated tube comprising multiple tubular layers (e.g., formed by one or more annular orifices), and a partial cross-section of the laminated tube may have a laminated structure similar to that shown in FIG. 1. In other embodiments, the glass article may be a shaped glass article, such as may be formed by shaping or molding a laminated sheet.

In some embodiments, the glass article 100 has a thickness of at least about 0.05 mm, at least about 0.1 mm, at least about 0.2 mm, or at least about 0.3 mm. Additionally or alternatively, the glass article 100 has a thickness of less than about 3 mm, less than about 2 mm, less than about 1.5 mm, less than about 1 mm, less than about 0.7 mm, or less than about 0.6 mm. In some embodiments, a ratio of a thickness of the core layer 102 to a thickness of the glass article 100 is at least about 0.5, at least about 0.7, at least about 0.8, at least about 0.85, at least about 0.9, or at least about 0.95. Additionally or alternatively, the ratio of the thickness of the core layer to the thickness of the glass article 100 is less than about 0.95, less than about 0.93, less than about 0.9, less than about 0.87, or less than about 0.85. In some embodiments, a thickness of the second layer (e.g., each of the first clad layer 104 and the second clad layer 106) is from about 0.01 mm to about 0.6 mm.

In some embodiments, the first glass composition and/or the second glass composition have a liquidus viscosity suitable for forming the glass article 100 using a fusion draw process as described herein. For example, the first glass composition of the core layer 102 may have a liquidus viscosity of at least about 100 kP, at least about 200 kP, or at least about 300 kP. Additionally or alternatively, the first glass composition comprises a liquidus viscosity of less than about 3000 kP, less than about 2500 kP, less than about 1000 kP, or less than about 800 kP. The second glass composition of the first and/or second clad layers 104 and 106 may have a liquidus viscosity of at least about 50 kP, at least about 100 kP, or at least about 200 kP. Additionally or alternatively, the second glass composition comprises a liquidus viscosity of less than about 3000 kP, less than about 2500 kP, less than about 1000 kP, or less than about 800 kP. The first glass composition can aid in carrying the second glass composition over the overflow distributor to form the second layer. Accordingly, the second glass composition can have a liquidus viscosity that is lower than generally considered suitable for forming a single layer sheet using a fusion draw process.

In various embodiments described herein, the glass article 100 is strengthened by a combination of mechanical strengthening and thermal tempering, or fictivation, and/or ion exchange. For example, the glass article 100 may have a CTE mismatch as described herein, and may be thermally tempered, or fictivated, to further improve the stress profile against deep flaws and improve Knoop and Vickers scratch performance. As another example, the glass article 100 may have a CTE mismatch as described herein, and may be ion exchanged to improve the stress profile against deep flaws.

### Mechanical Strengthening

In various embodiments, the glass article 100 is mechanically strengthened. For example, the second glass composition forming the first and/or second clad layers 104, 106 may have a different CTE than the first glass composition forming the core layer 102. In particular, in some embodiments, the first and second clad layers 104, 106 may be formed from a glass composition having a lower CTE than the glass composition of the core layer 102. The CTE mismatch (i.e., the difference between the CTE of the first and second clad layers 104, 106 and the CTE of the core layer 102) results in the formation of compressive stress in the clad layers and tensile stress in the core layer upon cooling of the glass article 100. In various embodiments, each of the first and second clad layers, independently, can have a higher CTE, a lower CTE, or substantially the same CTE as the core layer. Surface compressive stresses tend to suppress existing surface flaws from developing into cracks. Higher CTE mismatch results in higher surface compression in the clad layer. Additionally, a thicker clad layer results in a deeper depth of compression (DOC). However, such higher surface compressive stress and deeper DOC also result in increasing tensile stress in the core layer. Accordingly, the various factors should be balance with one another as described herein.

In embodiments, the CTE of the core layer 102 and the CTE of the first and/or second clad layers 104, 106 differ by at least about 5×10⁻⁷° C.⁻¹, at least about 15×10⁻⁷° C.⁻¹, at least about 25×10⁻⁷° C.⁻¹, or at least about 30×10⁻⁷° C.⁻¹. Additionally or alternatively, the CTE of the core layer 102 and the CTE of the first and/or second clad layers 104, 106 differ by less than about 100×10⁻⁷° C.⁻¹, less than about 75×10⁻⁷° C.^{-1,}, less than about 50×10⁻⁷° C.⁻¹, less than about 40×10⁻⁷° C.⁻¹, less than about 30×10⁻⁷° C.⁻¹, less than about 20×10⁻⁷° C.⁻¹, or less than about 10×10⁻⁷° C.⁻¹. For example, in some embodiments, the CTE of the core layer and the CTE of the first and/or second clad layers differ by about 5×10⁻⁷° C.⁻¹ to about 30×10⁻⁷° C.⁻¹, or about 5×10⁻⁷° C.⁻¹ to about 20×10⁻⁷° C.⁻¹. In some embodiments, the second glass composition of the first and/or second clad layer has a CTE of less than about 66×10⁻⁷° C.⁻¹, less than about 55×10⁻⁷° C.⁻¹, less than about 50×10⁻⁷° C.⁻¹, less than about 40×10⁻⁷° C.⁻¹, or less than about 35×10⁻⁷° C.⁻¹. Additionally or alternatively, the second glass composition of the first and/or second clad layer has a CTE of at least about 10×10⁻⁷° C.⁻¹, at least about 15×10⁻⁷° C.⁻¹, at least about 25×10⁻⁷° C.⁻¹, or at least about 30×10⁻⁷° C.⁻¹. The first glass composition of the core layer may have a CTE of at least about 40×10⁻⁷° C.⁻¹, at least about 50×10⁻⁷° C.⁻¹, at least about 55×10⁻⁷° C.⁻¹, at least about 65×10⁻⁷° C.⁻¹, at least about 70×10⁻⁷° C.⁻¹, at least about 80×10⁻⁷° C.⁻¹, or at least about 90×10⁻⁷° C.⁻¹. Additionally or alternatively, the first glass composition of the core layer may have a CTE of less than about 120×10⁻⁷° C.⁻¹, less than about 110×10⁻⁷° C.⁻¹, less than about 100×10⁻⁷° C.⁻¹, less than about 90×10⁻⁷° C.⁻¹, less than about 75×10⁻⁷° C.⁻¹, or less than about 70×10⁻⁷° C.⁻¹.

### Thermal Tempering

In various embodiments described herein, the glass article 100 is thermally tempered, or fictivated. In embodiments, the glass article 100 is heated to a first temperature that is from 50° C. to 200° C. greater than the glass transition temperature (T_{g}) of the clad layer, followed by equilibrating the glass article at the first temperature for a predetermined time period, and then quickly quenching the glass article to a second temperature below the lower strain point of the core layer or the clad layer. In some embodiments, the glass article is heated to a first temperature that is from 50° C. to 200° C. greater than the glass transition temperature (T_{g}) of the clad layer followed by equilibration at the first temperature and rapid quenching to a second temperature below the lower strain point of the clad layer or the core layer. In embodiments in which the first and second clad layers 104, 106 have different T_{g}s, the first temperature is greater than the higher T_{g}. In some embodiments, the first temperature is higher than the T_{g} of the clad layer and less than the T_{g} of the core layer. In other embodiments, the first temperature is higher than the T_{g} of the clad layer and the T_{g} of the core layer. In some embodiments, the first temperature is higher than the thickness weighted average T_{g} of the clad layer and the core layer. In some embodiments, the glass article is heated to a first temperature that is greater than or equal to 750° C. and less than or equal to 900° C., or greater than or equal to 775° C. and less than or equal to 875° C., or even greater than or equal to 790° C. and less than or equal to 860° C. In some embodiments, the second temperature is less than the strain point of the clad layer and less than the strain point of the core layer. In other embodiments, the second temperature is less than the strain point of the clad layer and higher than the strain point of the core layer. In some embodiments, the second temperature is less than the thickness weighted average strain point of the clad layer and the core layer. In some embodiments, the glass is fast cooled from the first temperature to a second temperature which is about room temperature (25° C.±10° C.).

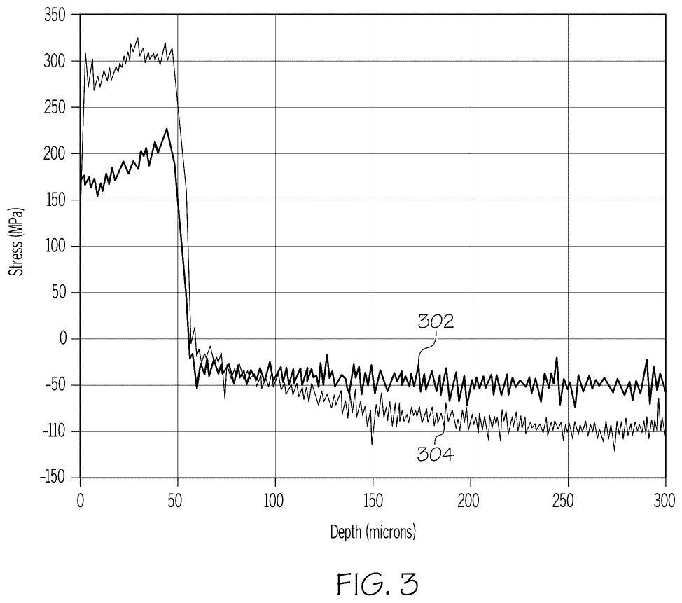

FIG. 3 is a graphical illustration comparing an example mechanical stress profile 302 generated by CTE mismatch alone and an example combined thermal mechanical stress profile 304 generated by thermal tempering and CTE mismatch. As shown in FIG. 3, the positive stress corresponds to a compressive stress while negative stresses correspond to a tensile stress. For the mechanical stress profile 302 and the combined thermal mechanical stress profile 304, the heat transfer coefficient was 0.03. Each of the glass articles was laminated with a core/clad ratio of 4.0 and a clad thickness of 55 μm. The stress profiles are represented by the stress as a function of depth within the glass article 100. The depth within the glass article 100, given as the distance from an outer surface of the glass article 100, is plotted on the x-axis and the stress is plotted on the y-axis.

The stress profile of a glass article can be measured using any suitable technique including, for example, using a birefringence based measurement technique or a refracted near-field (RNF) technique. For example, stress measurements can be performed according to ASTM C1422 and ATSM C1279. The stress profile comprises the stress in the glass article 100 as a function of depth within the glass article. The depth within the glass article 100, given as the distance from an outer surface of the glass article, is plotted on the x-axis, and the stress is plotted on the y-axis. The depth within the glass article may be referred to herein as depth of compression (DOC). Compressive stress is shown on the positive x-axis, and tensile stress is shown on the negative y-axis. However, the values of compressive and tensile stresses described herein refer to the absolute values of the stresses, or the magnitude of the stress. Thus, tensile stresses are given herein as positive values as opposed to negative values.

Referring to the mechanical stress profile 302, the compressive region (e.g., the clad layer) has a thickness of about 50 μm and a first compressive stress of about 150 MPa. Mechanical stress 302 is a step function. Thus, the compressive stress increases continuously from the surface compressive stress throughout the compressive region, and the stress transitions to the maximum tensile stress as a step-change at an interface region between the clad layer and the core layer).

Referring to the combined thermal mechanical stress profile 304, the compressive region extends to a depth of layer (DOL) of about 50 μm and has a surface compressive stress of at least 200 MPa. In various embodiments, the surface compressive stress is greater than 250 MPa. The compressive stress increases continuously with increasing distance from the outer surface of the clad layer from the surface compressive stress throughout the clad layer, transitions to the minimum tensile stress as a step-change at an interface region between the core layer and the clad layer, and a magnitude of tensile stress increases continuously from the step-change to the maximum tensile stress within the core layer. Thus, in contrast to the mechanical stress profile 302, the combined thermal mechanical stress profile 304 has a region of continuously increasing tensile stress in the core layer to the mid-point of the core layer.

Moreover, as can be seen in the combined thermal mechanical stress profile 304, the thermal tempering introduces a parabolic shape to the profile, particularly in the core layer, which may sometimes be referred to as the tensile region. Such a shape in the stress profile indicates that a flaw extending into the core layer will not peak until deeper into the depth of the glass article.

It will be recognized that FIG. 3 illustrates only a portion of each of the stress profiles through a portion of the thickness of the glass article (e.g., through one clad layer and a portion of the core layer). For a symmetrical glass article, the stress profile through the remaining portion of the thickness of the glass article is a mirror image of the illustrated portions of the stress profiles in FIG. 3.

The retained strength of a glass article can be determined based on the stress profile of the glass article. For example, the retained strength is determined by forming a flaw extending from a surface of the glass article to a specified depth and then determining the strength of the glass article after formation of the flaw. The strength is flexural strength of the glass article determined using, for example, a ring-on-ring test method (e.g., as described in ASTM C1499-09), a ball-on-ring test method, a three-point bend test method, a four-point bend test method, or another suitable method or technique. Such a retained strength determination can be conducted using a fracture mechanics simulation based on the stress profile of the glass article.

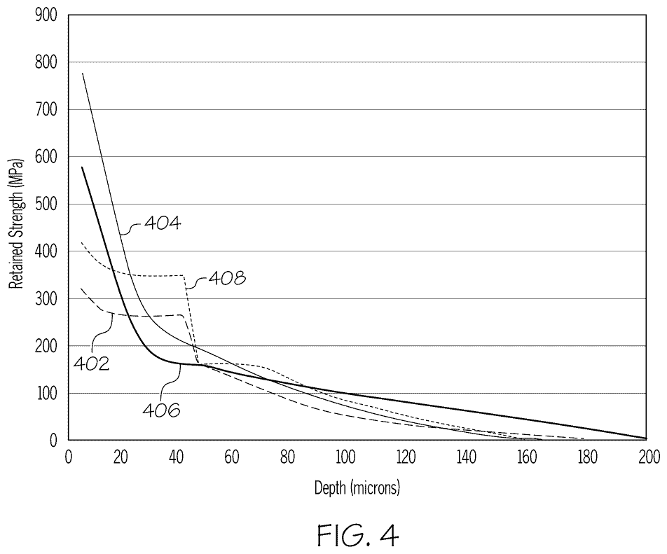

FIG. 4 is a graphical illustration comparing example retained strength profiles corresponding to stress profiles generated by mechanical strengthening alone, thermal tempering alone, and a combination of mechanical strengthening and thermal tempering. The retained strength profiles are represented by the retained strength as a function of flaw size. The flaw size, given as the distance from an outer surface of the glass article to the point to which the flaw extends, is plotted on the x-axis, and the retained strength is plotted on the y-axis.

The retained strength profiles 402, 404, 406 and 408 were generated using a fracture mechanics simulation. The mechanical retained strength profile 402 was based on a laminated glass article including CTE mismatch (e.g., mechanically strengthened). The thermal retained strength glass profiles 404 and 406 were based on single layer glass articles subjected to thermally tempering (e.g., thermally tempered). The combined retained strength profile 408 was based on a laminated glass article with CTE mismatch subjected to thermal tempering (e.g., mechanically strengthened and thermally tempered).

As shown in FIG. 4, each of the strength profiles has a relatively high retained strength (e.g., at least about 250 MPa) near the outer surface of the glass article, which can aid in avoiding breakage of the glass article as a result of relatively shallow falls (e.g., less than about 10 μm). However, the combined retained strength profile 408 maintains a higher retained strength than the mechanical retained strength profile 402 deeper into the glass article (e.g., to a distance further from the surface of the clad layer). For example, the retained strength of the combined retained strength profile 408 is higher than that of mechanical retained strength profiles 402 for flaw sizes from about 5 μm to about 140 μm, which can aid in avoiding breakage of the glass article as a result of relatively deep flaws. Moreover, the retained strength of the combined retained strength profile 408 remains comparable with that of the thermal retained strength glass profiles 404 and 406 for flaw sizes greater than about 40 μm, with a significant improvement in strength for flaw sizes from about 25 μm to about 40 μm. Thus, improved resistance to breakage resulting from such flaw sizes translates into improved drop performance for a cover glass having a retained strength profile similar to the combined retained strength profile 408.

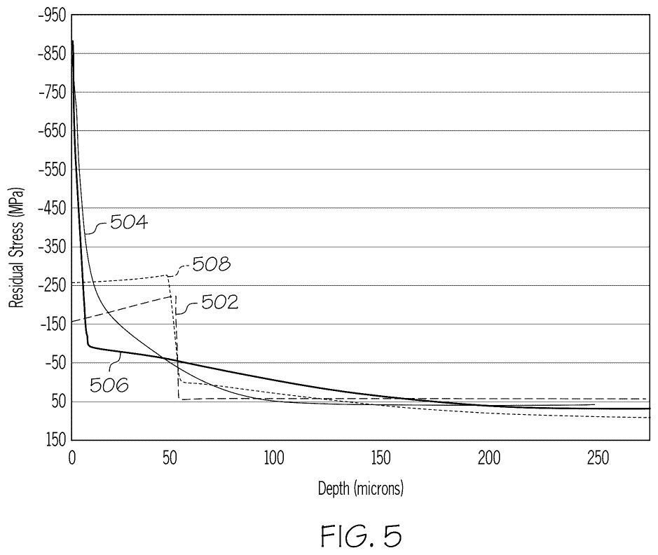

FIG. 5 depicts a residual stress model for the profiles depicted in FIG. 4. The residual stress profiles 502, 504, 506 and 508 were generated using a fracture mechanics simulation. The mechanical residual stress profile 502 was based on a laminated glass article including CTE mismatch. The thermal residual stress glass profiles 504 and 506 were based on single layer glass articles subjected to thermally tempering. The combined residual stress profile 508 was based on a laminated glass article with CTE mismatch subjected to thermal tempering.

As shown in FIG. 5, the combined residual stress profile 508 has a relatively constant amount of compressive stress for a depth of compression (DOC) of up to about 50 μm, which corresponds to the interface region between the clad layer and the core layer. The compressive stress in the combined residual stress profile 508 is significantly greater than the residual compressive stress in the comparative residual stress profiles for depths of at least 25 μm to 50 μm. Additionally, the compressive stress remains relatively constant through the DOC to the interface region, which may prevent surface flaws from developing into cracks. At the interface region between the clad layer and the core layer, the stress transitions from compressive stress in a step-change to a minimum tensile stress, which increases smoothly and continuously from the step-change through the core layer.

In addition to providing improved strength and stress profiles, in various embodiments, the combined mechanical and fictivation of the glass article can provide improved resistance to sharp contact damage events, as evidenced by the Vickers scratch threshold and indentation test performance and Knoop scratch test performance.

The Vickers indentation threshold measurements described herein are performed by applying and then removing an indentation load to the glass surface at a rate of 0.2 mm/min. The maximum indentation load is held for 10 seconds. The indentation threshold is defined at the indentation load at which 50% of 10 indents exhibit any number of radial/median cracks emanating from the corners of the indent impression. The maximum load is increased until the threshold is met for a given glass composition. All indentation measurements are performed at room temperature in 50% relative humidity.

The Vickers scratch threshold refers to the load at which lateral cracking is first observed in a glass article in response to scratching the surface of the glass article with a Vickers indenter at increasing load. The test procedure is similar to that used to determine Knoop scratch threshold, except that the Vickers indenter is substituted for the Knoop diamond. The lateral cracking is evidenced by sustained cracks in the glass article that are greater than twice the width of the original scratch or groove formed by the Vickers indenter.

Knoop scratch thresholds (KST) described herein are determined using a Knoop diamond indenter. The scratch threshold is determined by first identifying the load range for lateral crack onset. Once the load range is identified, a series of 5 mm long scratches under increasing constant load with three or more scratches per load are generated at a speed of 4 mm/s in order to identify the Knoop scratch threshold. Lateral cracks are defined as sustained cracks that are larger than twice the width of the groove.

Table 1 provides the change (A) in minimum and maximum Vickers scratch threshold, Vickers indentation threshold, and Knoop scratch threshold values for an example glass article having a thickness of 0.55 mm that was mechanically and thermally tempered (Example 1) as compared to an identical glass article that was mechanically strengthened.

TABLE 1
Δ Minimum and Maximum Values

| | Δ minimum | Δ maximum |
|---|---|---|
| Vickers | 1 N | 2 N |
| Indentation | | |
| (kg) | | |
| Knoop | 1 N | −1 N |
| Scratch | | |
| (N) | | |
| Vickers | 2 N | 3 N |
| Scratch | | |
| (N) | | |

As shown by the data provided in Table 1, the combination of thermal tempering and mechanical strengthening of the glass article can result in an increased minimum scratch/indentation fracture resistance, as well as an increased maximum both Vickers scratch and Vickers indentation values.

In one or more embodiments, the glass articles described herein further exhibit improved surface strength when subjected to abraded ring-on-ring (AROR) testing. The strength of a material is defined as the stress at which fracture occurs. The AROR test is a surface strength measurement for testing flat glass specimens, and ASTM C1499-09 (2013), entitled “Standard Test Method for Monotonic Equibiaxial Flexural Strength of Advanced Ceramics at Ambient Temperature,” serves as the basis for the AROR test methodology described herein. The contents of ASMT C1499-09 are incorporated herein by reference in their entirety. In embodiments, the glass specimen is abraded prior to ring-on-ring testing with 90 grit silicon carbide (SiC) particles that are delivered to the glass sample using the method and apparatus described in Annex A2, entitled “Abrasion Procedures,” of ASMT C158-02 (2012), entitled “Standard Test Methods for Strength of Glass by Flexure (Determination of Modulus of Rupture). The contents of ASTM C158-02 and the contents of Annex 2 in particular are incorporated herein by reference in their entirety.

Prior to ring-on-ring testing, a surface of the glass article is abraded as described in ASTM C158-02, Annex 2, to normalize and/or control the surface defect condition of the sample using the apparatus shown in Figure A2.1 of ASTM C158-02. The abrasive material is sandblasted onto the surface of the glass article at a predetermined pressure. After air flow is established, 5 cm³ of abrasive material is dumped into a funnel and the sample is sandblasted for 5 seconds after introduction of the abrasive material.

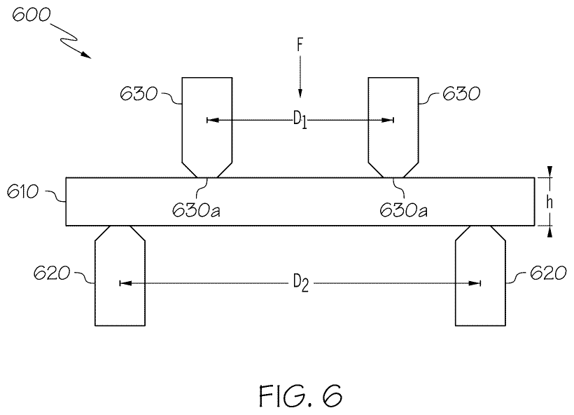

For the ring-on-ring test, a glass article having at least one abraded surface is placed between two concentric rings of differing size, as shown in FIG. 6, to determine equibiaxial flexural strength (i.e., the maximum stress that a material is capable of sustaining when subjected to flexure between two concentric rings). In the abraded ring-on-ring configuration 600, the abraded glass article 610 is supported by a support ring 620 having a diameter D2. A force F is applied by a load cell (not shown) to the surface of the glass article by a loading ring 630 having a diameter D1.

The ratio of the diameters of the loading ring and support ring D1/D2 may be in a range from about 0.2 to about 0.5. In some embodiments, D1/D2 is about 0.5. Loading and support rings 630, 620 should be aligned concentrically to within 0.5% of support ring diameter D2. The load cell used for testing should be accurate to within ±1% at any load within a selected range. In some embodiments, testing is carried out at a temperature of 23±2° C. and a relative humidity of 40±10%.

For fixture design, the radius r of the producing surface of the loading ring 630, h/2≤r≤3h/2, where h is the thickness of the glass article 610. Loading and support rings 630, 620 are typically made of hardened steel with hardness HRc>40. ROR fixtures are commercially available.

The intended failure mechanism for the ROR test is to observe fracture of the glass article 610 originating from the surface 630a within the loading ring 630. Failures that occur outside of this region—i.e., between the loading rings 630 and support rings 620—are omitted from data analysis. Due to the thinness and high strength of the glass article 610, however, large deflections that exceed ½ of the specimen thickness h are sometimes observed. It is therefore not uncommon to observe a high percentage of failures originating from underneath the loading ring 630. Stress cannot be accurately calculated without knowledge of stress development both inside and under the ring (collected via strain gauge analysis) and the origin of failure in each specimen. AROR testing therefore focuses on peak load at failure as the measured response.

The strength of the glass article depends on the presence of surface flaws. However, the likelihood of a flaw of a given size being present cannot be precisely predicted, as the strength of glass is statistical in nature. A probability distribution can therefore generally be used as a statistical representation of the data obtained.

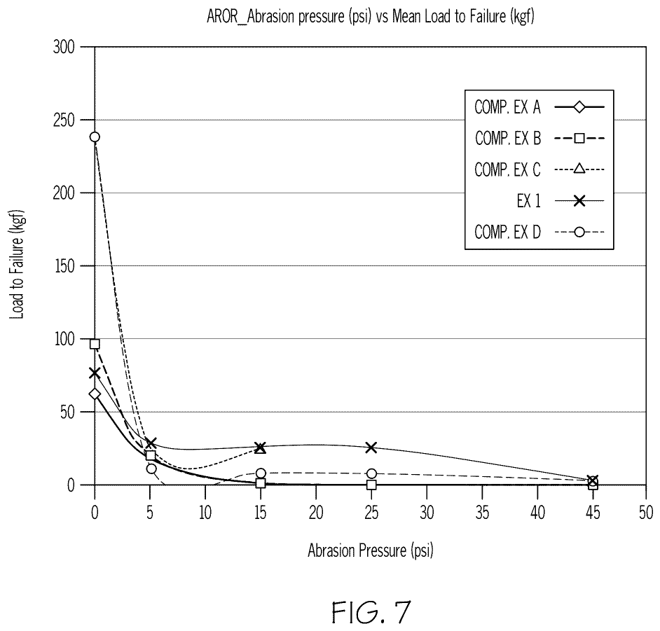

FIG. 7 depicts a graph of the load to failure (on the y-axis) as a function of the abrasion pressure (on the x-axis) for Example 1 and Comparative Examples A, B, C, and D. Table 2 provides a description of Example 1 and Comparative Examples A-D.

TABLE 2
Description of Example 1 and
Comparative Examples A-D

| | Thickness | |
|---|---|---|
| Sample | (mm) | Condition |
| Example | 0.55 | Laminated; |
| 1 | | thermal |
| | | tempered |
| Comp. | 0.3 | Laminated; |
| Ex. A | | NIX |
| Comp. | 0.3 | Laminated; |
| Ex. B | | IOX |
| Comp. | 0.55 | Laminated; |
| Ex. C | | IOX |
| Comp. | 0.5 | IOX; single |
| Ex. D | | layer |

As shown in FIG. 7, for pressures above about 5 psi, Example 1 exhibits a substantially constant retained strength until about 35 psi. Accordingly, the glass article that is mechanically and thermally strengthened is relatively insensitive to the depth of damage, whereas the Comparative Examples exhibit greater changes in strength over the same interval. FIG. 7 also demonstrates that the fictivated laminate had exceptional performance, exhibiting almost twice the retained strength at 25 psi than Comparative Example D.

In various embodiments, the second layer (e.g., the first clad layer 104 and/or the second clad layer 106) comprise a relatively low CTE, ion-exchangeable glass composition, and the first layer (e.g., the core layer 102) comprises a relatively high CTE ion-exchangeable glass composition. Exemplary glass compositions that may be suitable for use in the second layer include those described in U.S. Patent Application Publication No. 2014/00141217 and U.S. Patent Application Publication No. 2015/0030827, each of which is incorporated herein by reference in its entirety. Exemplary glass compositions that may be suitable for use in the first layer include those described in U.S. Patent Application Publication No. 2014/00141217 and U.S. Patent Application Publication No. 2015/0037552, each of which is incorporated herein by reference in its entirety.

### Chemical Strengthening

In various embodiments described herein, the glass article 100 may be strengthened by a combination of mechanical strengthening and chemical strengthening as an alternative to, or in addition to, thermal tempering. For example, the glass article 100 may have a CTE mismatch as described herein, and may be chemically strengthened to further increase the compressive stress through at least the clad layer as compared to lamination or CTE mismatch alone.

In various embodiments described herein, after being mechanically strengthened as described in detail above, the glass article 100 is chemically strengthened. For example, the glass article 100 may be subjected to a dual ion exchange treatment to increase the compressive stress in a region of the glass article at an outer surface of the glass article (e.g., an outer portion of the clad layer). In some embodiments, the ion exchange treatment comprises applying an ion exchange medium to one or more surfaces of the glass article 100 or otherwise contacting the laminated glass article 100 with an ion exchange medium (e.g., an ion exchange bath). The ion exchange medium may be a solution, a paste, a gel, or another suitable medium comprising one or more ion sources or sources of larger ions to be exchanged with smaller ions in the glass network (e.g., the glass network of the second layer). The terms “larger ions” and “smaller ions” are relative terms, meaning that the larger ions are relatively large compared to the smaller ions and the smaller ions are relatively small compared to the larger ions. Thus, the larger ions have a larger ionic radius than the smaller ions, and the smaller ions have a smaller ionic radius than the larger ions. In some embodiments, the second layer of the glass article 100 comprises an alkali aluminosilicate glass. Thus, the smaller ions in the surface layer of the glass and the larger ions in the ion exchange medium may be monovalent alkali metal cations (e.g., Li⁺, Na⁺, and/or K⁺). Alternatively, monovalent cations in the glass article 100 may be replaced with monovalent cations other than alkali metal cations (e.g., Ag⁺ or the like). In some embodiments, the second layer of the glass article 100 comprises an alkaline earth aluminosilicate glass. In some embodiments, the ion exchange medium comprises a molten salt solution, and the ion exchange treatment comprises immersing the laminated glass article in a molten salt bath comprising larger ions to be exchanged with smaller ions (e.g., Na⁺, Li⁺, Ca²⁺, and/or Mg²⁺) in the glass matrix. In some embodiments, the molten salt bath comprises a salt (e.g., a nitrate, a sulfate, and/or a chloride) of the larger ions. For example, the molten salt bath may include molten KNO₃, molten NaNO₃, or a combination thereof. Additionally or alternatively, the temperature of the molten salt bath may be from about 380° C. to about 450° C., and an immersion time is from about 2 hours to about 16 hours.

In various embodiments described herein, the ion exchange medium includes at least two ion sources (e.g., at least two cations). In some embodiments, a single ion exchange medium may include both ion sources, while in other embodiments, a first ion exchange medium may include a first ion source while a second ion exchange medium may include a second ion source. For example, in some embodiments, the ion exchange medium may include Na⁺ and K⁺ ions (or salts thereof), which may be used to adjust the stress at different points in the stress profile. In other embodiments, the glass article may be contacted with a first ion exchange medium that includes Na⁺ ions and then may be contacted with a second ion exchange medium that includes K⁺ ions. By replacing smaller ions in the glass matrix with larger ions at the surface of the glass article 100, the compressive stress of the second layer is increased at the outer surface of the glass article. For example, during the ion exchange treatment, the larger ions from the ion exchange medium diffuse into an outer portion of the second layer of the glass article 100 and the smaller ions from the glass matrix diffuse out of the outer portion of the second layer of the glass article. Thus, the outer portion of the second layer comprises an exchanged region of the glass article. The increased concentration of the larger ions in the ion exchanged region causes crowding of the glass network and increases the compressive stress of the glass article 100 in the ion exchanged region. In some embodiments, subjecting the glass article 100 to the ion exchange treatment increases a surface compressive stress at the outer surface of the glass article (e.g., from an initial surface compressive stress generated by the CTE mismatch) to a final compressive stress value. For example, the final compressive stress value is at least about 200 MPa, at least about 300 MPa, at least about 400 MPa, at least about 500 MPa, at least about 600 MPa, at least about 700 MPa, at least about 800 MPa, at least about 900 MPa, or at least about 1,000 MPa. Additionally or alternatively, the final compressive stress value is less than about 1300 MPa, less than about 1200 MPa, less than about 1000 MPa, less than about 900 MPa, or less than about 800 MPa.

Moreover, in various embodiments, the glass article may have a depth of compression (DOC) of greater than or equal to 50 μm. For example, the glass article may have a DOC of greater than or equal to 70 μm, greater than or equal to 100 μm, or even greater than or equal to 200 μm. The DOC may be achieved by ion exchange in addition to increasing a thickness of the clad layer.

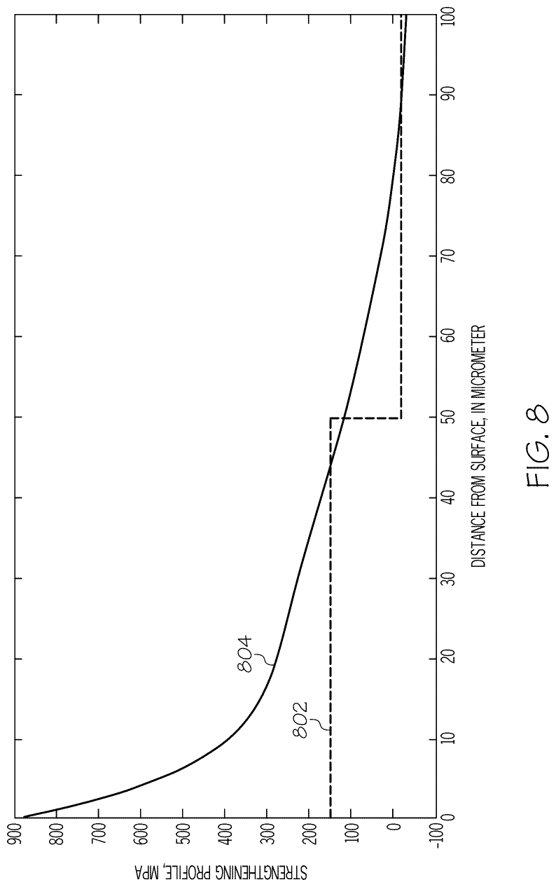

FIG. 8 is a graphical illustration comparing an example mechanical stress profile 802 generated by CTE mismatch alone and an example chemical stress profile 804 generated by chemical strengthening alone. The stress profiles are represented by the stress as a function of depth within the glass article 100. The depth within the glass article 100, given as the distance from an outer surface of the glass article 100, is plotted on the x-axis and the stress is plotted on the y-axis.

Referring to the mechanical stress profile 802, the compressive region (e.g., the clad layer) has a thickness (e.g., a DOC) of about 50 μm and a first compressive stress of about 150 MPa. Mechanical stress 302 is a step function. Thus, the compressive stress remains substantially constant from the surface through the clad layer, and transitions to the maximum tensile stress as a step-change at an interface region between the clad layer and the core layer.

Referring to the chemical stress profile 804, the compressive region extends to a depth of compression (DOC) of about 80 μm and has a surface compressive stress of about 900 MPa. The stress transitions continuously from the surface compressive stress at the outer surface of the compressive region to the maximum tensile stress within the tensile region. Thus, in contrast to the mechanical stress profile 802, the chemical stress profile 804 does not have a region of constant compressive stress or a step-change between the compressive stress region and the tensile region.

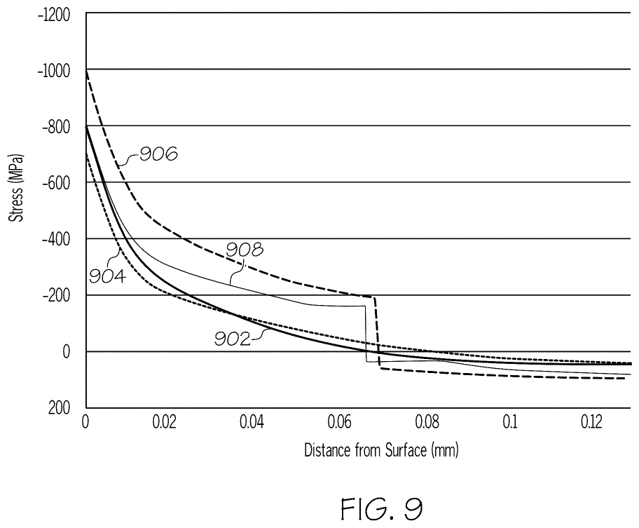

In various embodiments, the glass article 100 is strengthened by a combination of mechanical strengthening and chemical strengthening. For example, the glass article 100 having a CTE mismatch as described herein (e.g., a glass laminate) is chemically strengthened to further increase the compressive at the outer surface of the compressive layer. FIG. 9 is a graphical illustration of various examples of stress profiles formed from chemical strengthening and combined stress profiles formed a combination of mechanical strengthening and chemical strengthening.

It will be recognized that FIG. 9 illustrates only a portion of each of the stress profiles through a portion of the thickness of the glass article (e.g., through one clad layer and a portion of the core layer). For a symmetrical glass article (e.g., a core layer positioned between two clad layers having identical thickness and glass composition), the stress profiles through the remaining portion of the thickness of the glass article is a mirror image of the illustrated portions of the stress profiles in FIG. 9. In the examples shown in FIG. 9, the stress profile 902 and the stress profile 904 correspond to profiles for glass that was chemically strengthened using a dual ion exchange treatment as described herein. The stress profile 906 and the stress profile 908 are stress profiles for glass articles that were mechanically strengthened and chemically strengthened using a dual ion exchange treatment. In particular, the glass article that has the stress profile 908 has a lower CTE difference between laminate layers, a lower peak CS, and a shallower depth of layer for the ion exchange and step-change. Stress profile 902 corresponds to the dual ion exchanged used for the glass laminate of stress profile 906 and stress profile 904 corresponds to the dual ion exchange used for the glass laminate of stress profile 908.

The compressive stress in each of stress profiles 906 and 908 decreases continuously from a first compressive stress of about 1000 MPa and 800 MPa, respectively, with increasing distance from the outer surface of the clad layer and then transitions to the minimum tensile stress as a step-change at an interface region between the core layer and the clad layer. A magnitude of tensile stress increases continuously from the step-change to the maximum tensile stress in the core layer. In contrast, the compressive stress in each of the stress profiles 902 and 904 decreases continuously with increasing distance from the outer surface of the clad layer and smoothly transitions to a maximum tensile stress in the core layer.

In some embodiments, the glass article 100 is chemically strengthened to increase the compressive stress throughout the clad layer. Thus, the chemical strengthening is performed in such a manner that nearly the entire thickness of the clad layer is chemically strengthened and the stress is increased throughout the compressive layer as compared to a non-laminated glass exposed to the same ion exchange treatment.

The retained strength of a glass article can be determined based on the stress profile of the glass article. For example, the retained strength is determined by forming a flaw extending from a surface of the glass article to a specified depth and then determining the strength of the glass article after formation of the flaw.

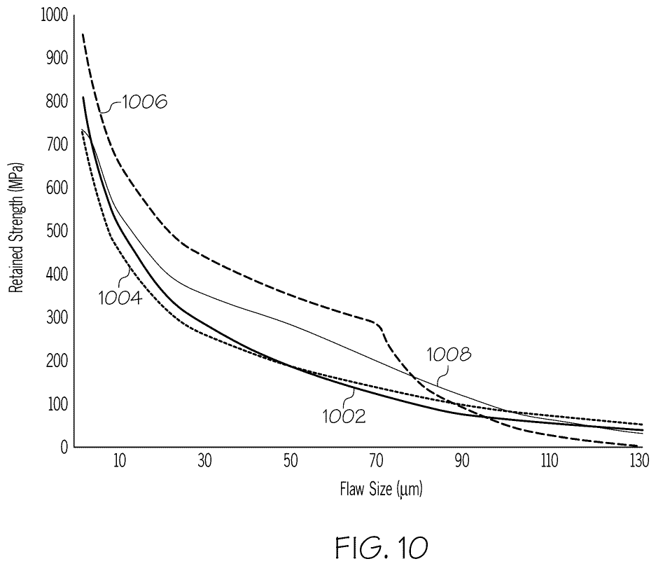

FIG. 10 is a graphical illustration comparing example retained strength profiles corresponding to stress profiles generated by chemical strengthening alone and a combination of mechanical strengthening and chemical strengthening. The retained strength profiles are represented by the retained strength as a function of flaw size. The flaw size, given as the distance from an outer surface of the glass article to the point to which the flaw extends, is plotted on the x-axis, and the retained strength is plotted on the y-axis.

Chemical retained strength profiles 1002 and 1004 were generated using a fracture mechanics simulation based on the chemical stress profiles 902 and 904 shown in FIG. 9, respectively. Combined retained strength profiles 1006 and 1008 were generated using a fracture mechanics simulation based on the combined stress profiles 906 and 908 shown in FIG. 9, respectively.

As shown in FIG. 10, each of the strength profiles has a relatively high retained strength (e.g., at least about 200 MPa) near the outer surface of the glass article, which can aid in avoiding breakage of the glass article as a result of relatively shallow falls (e.g., less than about 10 μm). However, the combined retained strength profiles 1006 and 1008 maintain a higher retained strength than the chemical retained strength profiles 1002 and 1004 deeper into the glass article. For example, the retained strength of the combined retained strength profiles 1006 and 1008 is higher than that of chemical retained strength profiles 1002 and 1003 for flaw sizes from about 5 μm to about 90 μm, which can aid in avoiding breakage of the glass article as a result of relatively deep flaws. Thus, improved resistance to breakage resulting from such flaw sizes translates into improved drop performance for a cover glass having a retained strength profile similar to the combined retained strength profile 1006 and/or the combined retained strength profile 1008. Moreover, the improved resistance to breakage resulting from large flaws can be achieved by the combined retained strength profile 1006 and/or the combined retained strength profile 1008 without substantially increasing the maximum tensile stress of the tensile region as compared to the retained strength profile 1002 and/or the retained strength profile 1004. For example, increasing the compressive stress relatively deep into the compressive region (e.g., such as by increasing the DOC) can help to maintain the area under the compressive portion of the stress profile curve, which is proportional to the maximum tensile stress in the tensile region, relatively low while also providing protection against breakage caused by relatively deep flaws. Thus, the maximum tensile stress can be maintained below the frangibility limit. Additionally or alternatively, the thickness of the compressive region is sufficiently large to maintain relatively high compressive stress deep into the glass article (e.g., to achieve improved resistance to breakage resulting from large flaws) without increasing the maximum tensile stress to an unacceptable level (e.g., above the frangibility limit). The frangibility limit can be determined, for example, as described in U.S. Patent Application Publication No. 2010/0035038, which is incorporated herein by reference in its entirety.

The high surface compression can help to prevent flaws from propagating within the depth of the glass article. Additionally, the continued high compression level, although decreasing with increasing depth, meets the flaw through a greater depth of the glass article described herein. Such an increase in compressive stress can help to arrest the propagation of the flaw. Thus, the increased compression can provide improved resistance to flaw propagation compared to a glass article strengthened by mechanical strengthening alone. Moreover, because the clad layer is under compressive stress from the CTE mismatch prior to any chemical strengthening, the glass article can have a higher surface compressive stress compared to a glass article strengthened by ion exchange alone. Thus, by combining mechanical strengthening and dual ion exchange, the benefits of the compressive peak can be achieved without sacrificing the relatively high surface compressive stress that can help to prevent formation of surface flaws.

If a flaw does propagate beyond surface, the compressive stress extending relatively deep into the glass article can help to prevent failure of the glass article as a result of the flaw (e.g., by preventing the flaw from reaching the core layer that is in tension). Thus, the presence of the increased compression through a greater depth of the glass article (e.g., provided by mechanical strengthening) can provide improved resistance to failure compared to a glass article strengthened by chemical strengthening alone and having a rapidly decreasing compressive stress deeper into the glass article. Accordingly, the stress profile generated by the combination of mechanical strengthening and dual ion exchange strengthening as described herein can enable improved performance of the glass article compared to conventional strengthening techniques.

In some embodiments, the position of the compressive peak can be tailored to form a glass article with a determined stress profile adapted for a particular application. For example, the time and/or the temperature for the ion exchange region can be increased such that the ion exchanged region of the second layer extends deeper into the glass article. Thus, the position of the compressive peak can be shifted deeper into the glass article. Alternatively, the time and/or temperature of the ion exchange treatment can be decreased such that the ion exchanged region of the second layer extends shallower into the glass article. Thus, the position of the compressive peak can be shifted shallower into the glass article. Positioning the compressive peak deeper within the glass article can help to improve the reliability of the glass article, represented by retained strength, compared to positioning the compressive peak shallower within the glass article, for the same central tension. However, positioning the compressive peak shallower within the glass article can help to improve the strength of the glass article compared to positioning the compressive peak deeper within the glass article, for the same central tension. Thus, the compressive peak can be positioned to balance strength and reliability.

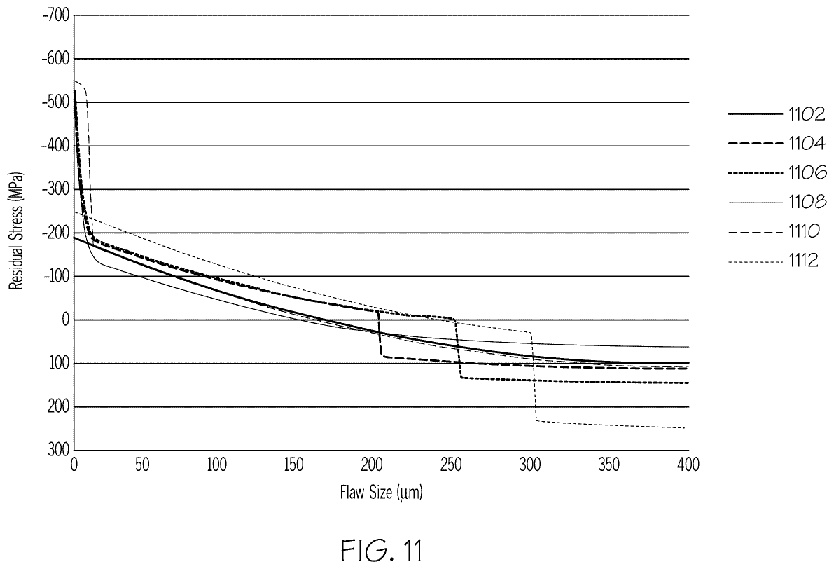

Moreover, in various embodiments, the thickness of the clad layer may be adjusted to provide for a varying depth of compression (DOC) as well as improved retained strength for flaws of various ranges. FIG. 11 depicts various stress profiles that have been adjusted to provide various depths of compression. In FIG. 11, stress profile 1102 corresponds to a single glass sheet that was ion exchanged. Accordingly, stress profile 1102 has a parabolic shape and a compressive stress spike at the surface. In other words, the compressive stress peaks at the surface of the glass article, and decreases continuously, smoothly transitioning from compression to tension and to a maximum tension at the middle of the glass article. Stress profiles 1104 and 1106 correspond to laminated glass articles with 200 μm and 250 μm thick clad layers, respectively. Each glass article was ion exchanged. Accordingly, each stress profile has a compressive stress spike at the surface of the glass article, and the compressive stress decreases continuously with increasing distance from the surface, then transitions to a minimum tensile stress as a step-change at an interface region between the core layer and the clad layer, and the magnitude of tensile stress increases continuously from the step-change to a maximum tensile stress. By comparing stress profile 1104 to stress profile 1106, it can be seen that the increased thickness of the clad layer increases the depth of compression from about 200 μm to about 250 μm.

Stress profiles 1108 and 1110 correspond to single layer glass articles that were ion-exchanged. As shown in FIG. 11, stress profile 1108 is parabolic in shape, having a compressive stress that decreases with increasing distance from an outer surface of the clad layer and smoothly transitions to a tensile stress. In contrast, stress profile 1110 includes a compressive stress spike at the outer surface of the clad layer, and the compressive stress decreases continuously with increasing distance from the outer surface of the clad layer, transitioning smoothly to a tensile stress. Stress profile 1112 corresponds to a glass laminate having a clad layer with a thickness of 300 μm, which drives the depth of compression deeper into the thickness of the glass. Additionally, in contrast to stress profiles 1104 and 1106, stress profile 1112 does not have a compressive stress spike at the surface of the clad layer. Accordingly, the compressive stress decreases with increasing distance from the outer surface of the clad layer, transitioned to a minimum tensile stress as a step-change at an interface region between the core layer and the clad layer, and a magnitude of tensile stress increases continuously from the step-change to a maximum tensile stress in the core layer.

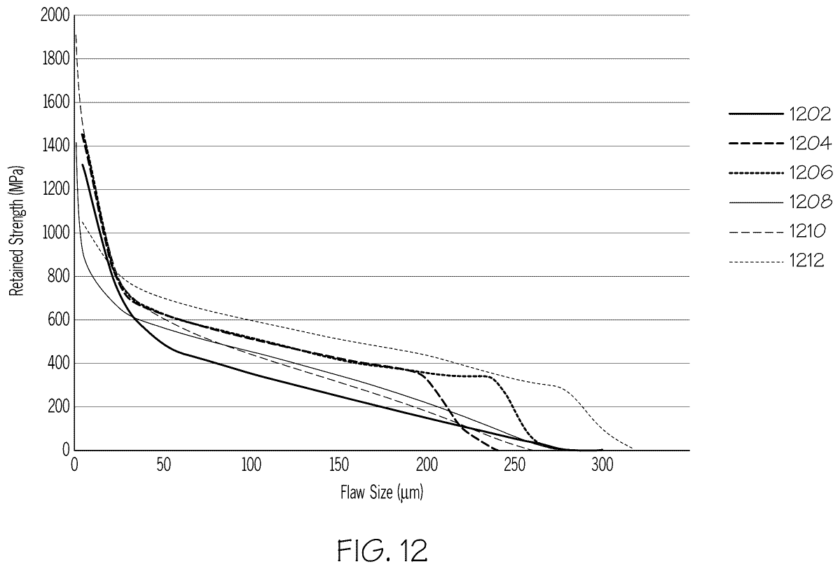

FIG. 12 depicts the retained strength profiles that correspond to the stress profiles depicted in FIG. 11. As can be seen, the lamination of the glass articles coupled with ion-exchange treatment increases the strength for most flaw sizes, and increasing the depth of compression further increases the strength deeper into the glass article. In particular, strength profile 1212 exhibits a retained strength of greater than 300 MPa to a flaw size of nearly 275 μm, whereas strength profiles 1204 and 1206 exhibit similar strengths to flaw sizes of about 200 μm and 250 μm respectively. For single layer glass sheets, the strength profiles 1202, 1208, and 1210 have a continuously decreasing strength that drops below about 200 MPa at or before a depth of 200 μm. Accordingly, the retained strength can be adjusted by adjusting the DOC to address flaws of various sizes.

The glass articles described herein can be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, and tablet computers; for integrated circuit applications including, for example, semiconductor wafers; for photovoltaic applications; for architectural glass applications; for automotive or vehicular glass applications; or for commercial or household appliance applications. In various embodiments, a consumer electronic device (e.g., smartphones, tablet computers, personal computers, ultrabooks, televisions, and cameras), an architectural glass, and/or an automotive glass comprises a glass article as described herein.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A laminated glass article comprising:
a core layer comprising a core glass composition having an average core coefficient of thermal expansion (CTE_{core});
a clad layer directly adjacent to the core layer and comprising a clad glass composition having an average clad coefficient of thermal expansion (CTE_{clad}) that is less than the CTE_{core} such that the clad layer is in compression and the core layer is in tension;
wherein a compressive stress of the clad layer decreases with increasing distance from the outer surface of the clad layer, transitions to a minimum tensile stress as a step-change at an interface region between the core layer and the clad layer, and a magnitude of tensile stress increases continuously from the step-change to a maximum tensile stress in the core layer.

2. The laminated glass article according to claim 1, wherein a surface compressive stress of the clad layer is at least 500 MPa.

3. The laminated glass article according to claim 1, wherein the minimum tensile stress is at least 50 MPa.

4. The laminated glass article according to claim 1, wherein the compressive stress decreases with increasing distance from the outer surface of the clad layer in according to a non-linear relationship.

5. The laminated glass article according to claim 1, wherein the tensile stress increases to a maximum tensile stress according to a non-linear relationship.

6. A method of preparing a glass article comprising:
laminating at least one core layer and at least one clad layer to form a laminated glass article, the at least one core layer comprising an ion-exchangeable core glass composition having an average core coefficient of thermal expansion (CTE_{core}) and the at least one clad layer comprising an ion-exchangeable clad glass composition having an average clad coefficient of thermal expansion (CTE_{clad}) that is less than the CTE_{core} such that the at least one clad layer is in compression and the at least one core layer is in tension; and
contacting the laminated glass article with an ion exchange bath comprising a first ion source and a second ion source;
wherein after the contacting the laminated glass article has a depth of compression (DOC) of greater than or equal to 50 μm.

7. The method according to claim 6, wherein after the contacting, the laminated glass article has a DOC of greater than or equal to 70 μm.

8. The method according to claim 6, wherein after the contacting, the laminated glass article has a DOC of greater than or equal to 100 μm.

9. The method according to claim 6, wherein after the contacting, the laminated glass article has a DOC of greater than or equal to 200 μm.

10. The method according to claim 6, wherein the ion exchange bath is a first ion exchange bath, the method further comprising contacting the laminated glass article with a second ion exchange bath comprising at least one additional ion source.

11. The method according to claim 6, wherein the first ion source comprises a source of sodium ions, and the second ion source comprises a source of potassium ions.

12. The method according to claim 6, wherein contacting the laminated glass article with an ion exchange bath comprises contacting the laminated glass article with a first ion exchange bath comprising the first ion source and subsequently contacting the laminated glass article with a second ion exchange bath comprising the second ion source.

13. The method according to claim 6, further comprising, prior to contacting the laminated glass article with the ion exchange bath:
heating the laminated glass article to a first temperature that is from 50° C. to 200° C. greater than a glass transition temperature T_{g} of the laminated glass article;
equilibrating the laminated glass article at the first temperature for a predetermined period of time; and
quenching the laminated glass article to a second temperature.
